(19) United States
(12) Patent Application Publication
(10) Pub. No.: US 2014/0280230 A1
(43) Pub. Date: Sep. 18, 2014

(54) HIERARCHICAL ORCHESTRATION OF DATA PROVIDERS FOR THE RETRIEVAL OF POINT OF INTEREST METADATA

(71) Applicant: QUALCOMM INCORPORATED, San Diego, CA (US)

(72) Inventors: Daniele MASATO, Cambridge (GB); David T. BERRY, Cambridge (GB); Andrew C. HECKFORD, Cambridge (GB)

(73) Assignee: QUALCOMM Incorporated, San Diego, CA (US)

(21) Appl. No.: 13/801,326

(22) Filed: Mar. 13, 2013

(51) Int. Cl. G06F 17/30

(52) U.S. Cl. CPC G06F 17/30041
USPC 707/749

(57) ABSTRACT

Various embodiments relate to systems, methods, apparatus, and computer readable media for querying data providers in point of interest searches. In one particular embodiment, a method is provided that includes identifying a plurality of data sources each having a data source priority, the plurality of data sources comprising at least two of: a first reference source, a first structured knowledge base, and a first individual website. The plurality of data sources may then be queried for metadata associated with the POI search request, wherein an order of the querying is based on the data source priority for each of the plurality of data sources; and at least one source quality measured for at least one of the plurality of data sources. In further embodiments, a query order may be updated based on the measured source quality.

### BACKGROUND

Aspects of the disclosure relate to networked computing technologies and searches. In particular, aspects of the disclosure relate to systems, methods, apparatus, and computer readable media for querying data providers in point of interest searches.

As mobile computing devices such as smartphones become more common and integrate more features, specialized “point of interest” searches are becoming a common feature. A point of interest search is a search for physical locations that conform to a set of characteristics. Typically the search is anchored to a reference location, such as the location of the device or user that is originating the search. The search may also include requests for additional information about the points of interest such as business hours or contact information for a business at the point of interest.

### BRIEF SUMMARY

Various embodiments are described herein including systems, methods, apparatus, and computer readable media for sorting and organizing data providers in point of interest searches. For example, one embodiment is described which includes a method comprising: processing at a computing device, a point of interest (POI) search request; identifying a plurality of data sources each having a data source priority, the plurality of data sources comprising at least two of: a first reference source, a first structured knowledge base, and a first individual website; querying the plurality of data sources for metadata associated with the POI search request, wherein a query order is based on the data source priority for each of the plurality of data sources; measuring at least one source quality for each of the plurality of data sources. Such an embodiment may further comprise receiving, in response to querying the plurality of data sources, metadata entries from the plurality of data sources which match the POI search request; merging the metadata entries from the plurality of data sources using a language analysis module to create merged metadata from the plurality of data sources; responding to the POI search request using the merged metadata; and updating the data source priority for the plurality of metadata sources using the at least one source quality for each of the plurality of data sources.

Additional implementations of such an embodiment may function where the plurality of data sources comprises the first reference source and the first structured knowledge base; wherein a data source priority for the first reference source is greater than a data source priority for the first structured knowledge base; wherein querying the plurality of data sources comprises: querying the first reference source for metadata associated with the point of interest search request; and after querying the first reference source, querying the first structured knowledge base for metadata associated with the point of interest search request after querying the first reference source.

Still further implementations of such an embodiment may function where measuring at least one source quality for each of the plurality of data sources comprises: measuring a first reference source response time; and measuring a first structured knowledge base response time or where the plurality of data sources further comprises the first individual website.

Additional implementations of such an embodiment may function where the data source priority for the first structured knowledge base is greater than the data source priority for the first individual website; and wherein querying the plurality of data sources further comprises: after querying the first structured knowledge base, querying the first individual website.

Additional implementations of such an embodiment may function where the data source priority for the first reference source, the data source priority for the first structured knowledge base, and the data source priority for the first individual website are each default data source priorities.

Additional implementations of such an embodiment may function where a default data source priority for each reference source of the plurality of data sources is greater than a default data source priority for each structured knowledge base of the plurality of data sources.

Additional implementations of such an embodiment may function where the default data source priority for each structured knowledge base of the plurality of data sources is greater than the default data source priority for each individual web page of the plurality of data sources.

Additional implementations of such an embodiment may further include identifying conflicting metadata entries from the first reference source, the first structured knowledge base, and the first individual website and removing the conflicting metadata entries from the merged metadata prior to responding to the POI search request.

Additional implementations of such an embodiment may include querying the first reference source and a second online reference source; identifying an individual POI from first individual POI metadata of the first reference source and second individual POI metadata from a second online reference source; identifying first individual POI compatible metadata and first individual POI conflicting metadata from the first individual POI metadata and the second individual POI metadata; using the first individual POI compatible metadata and removing the first individual POI conflicting metadata to create a first individual POI merged metadata; and responding to the POI search request with the first individual POI merged metadata prior to querying the first structured knowledge base.

Additional implementations of such an embodiment may include identifying the individual POI from third individual POI metadata of the first structured knowledge base; identifying second individual POI compatible metadata and second individual POI conflicting metadata from the first individual POI merged metadata and the third individual POI metadata; updating the first individual POI merged metadata using the second individual POI compatible metadata and the second individual POI conflicting data to create second individual POI merged metadata; and updating the response to the POI search request by responding to the POI search request with the second individual POI merged metadata.

Additional implementations of such an embodiment may function where the data source priority comprises one or more of an expected response time, a user preference selection, or a data quality measurement. Additional implementations of such an embodiment may function where identifying metadata entries from the plurality of data sources which match the POI search request comprises: receiving responses to the querying of the plurality of data sources, the responses comprising individual POI metadata; and updating, over time as the responses are received, the merged metadata by identifying compatible metadata and conflicting metadata for each individual POI using the language analysis module; and wherein responding to the POI search request using the merged metadata comprises communicating a plurality of merged metadata updates as the responses are received and the merged metadata is updated over time.

Additional implementations of such an embodiment may function where merging the metadata entries from the plurality of data sources using the language analysis module to create the merged metadata comprises including the compatible metadata for each individual POI result in the merged metadata and excluding the conflicting metadata from the merged metadata; and wherein responding to the POI search request comprises communicating the merged metadata updates each time the merged metadata is updated as responses to queries are received.

An alternative embodiment may be a non-transitory computer readable instruction medium comprising instructions that, when executed by a processor, cause a computing device to perform a method comprising: processing a point of interest (POI) search request; identifying a plurality of data sources each having a data source priority, the plurality of data sources comprising at least two of: a first reference source, a first structured knowledge base, and a first individual website; querying the plurality of data sources for metadata associated with the POI search request, wherein a query order is based on the data source priority for each of the plurality of data sources; measuring at least one source quality for each of the plurality of data sources; receiving, in response to querying the plurality of data sources, metadata entries from the plurality of data sources which match the POI search request; merging the metadata entries from the plurality of data sources using a language analysis module to create merged metadata from the plurality of data sources; responding to the POI search request using the merged metadata; and updating the data source priority for the plurality of metadata sources using the at least one source quality for each of the plurality of data sources.

Additional embodiments of such a medium may function where the method further comprises: querying the first reference source and a second online reference source; identifying an individual POI from first individual POI metadata of the first reference source and second individual POI metadata from a second online reference source; identifying first individual POI compatible metadata and first individual POI conflicting metadata from the first individual POI metadata and the second individual POI metadata; using the first individual POI compatible metadata and removing the first individual POI conflicting metadata to create a first individual POI merged metadata; and responding to the POI search request with the first individual POI merged metadata prior to querying the first structured knowledge base.

Another alternative embodiment may be a computing device comprising: means for processing a point of interest (POI) search request; means for identifying a plurality of data sources each having a data source priority, the plurality of data sources comprising at least two of: a first reference source, a first structured knowledge base, and a first individual website; means for querying the plurality of data sources for metadata associated with the POI search request, wherein a query order is based on the data source priority for each of the plurality of data sources; means for measuring at least one source quality for each of the plurality of data sources; means for receiving, in response to querying the plurality of data sources, metadata entries from the plurality of data sources which match the POI search request; means for merging the metadata entries from the plurality of data sources using a language analysis module to create merged metadata from the plurality of data sources; means for responding to the POI search request using the merged metadata; and means for updating the data source priority for the plurality of metadata sources using the at least one source quality for each of the plurality of data sources.

Alternative embodiments of the computing device according to various embodiments may additionally comprise means for updating, from user input, the data source priority for each data source of the plurality of data sources; and means for creating multi-threaded user queries in communication with the plurality of data sources. Alternative embodiments of the computing device according to various embodiments may additionally comprise means for measuring a source quality of each of the plurality of data sources by identifying a correctness of metadata received from each data source.

An additional embodiment of the computing device may comprise means for processing a point of interest (POI) search request; means for identifying a plurality of data sources each having a data source priority, the plurality of data sources comprising at least two of: a first reference source, a first structured knowledge base, and a first individual website; means for querying the plurality of data sources for metadata associated with the POI search request, wherein an order of the querying is based on the data source priority for each of the plurality of data sources; and means for measuring at least one source quality for at least one of the plurality of data sources.

Another embodiment of the computing device may further include means for receiving, in response to querying the plurality of data sources, metadata entries from the plurality of data sources which match the POI search request; means for merging the metadata entries from the plurality of data sources to create merged metadata from the plurality of data sources; means for responding to the POI search request using the merged metadata; and means for updating the data source priority for at least one of the data sources using the at least one source quality for the at least one of the plurality of data sources.

Another embodiment of the computing device may further include means for receiving, in response to querying the plurality of data sources, metadata entries from the plurality of data sources which match the POI search request; means for merging the metadata entries from the plurality of data sources using a language analysis module to create merged metadata from the plurality of data sources; means for responding to the POI search request using the merged metadata; and means for updating the data source priority for at least one of the data sources using the at least one source quality for the at least one of the plurality of data sources.

Another embodiment of the computing device may further function where the plurality of data sources comprises the first reference source and the first structured knowledge base; wherein a data source priority for the first reference source is greater than a data source priority for the first structured knowledge base; and wherein querying the plurality of data sources comprises: means for querying the first reference source for metadata associated with the POI search request; and means for querying the first structured knowledge base for metadata associated with the POI search request after querying the first reference source.

Another embodiment of the computing device may further include means for measuring a response time of the first reference source; and means for measuring a response time of the first structured knowledge base. Another embodiment of the computing device may function where the plurality of data sources further comprises the first individual website.

Another embodiment of the computing device may further include means for identifying conflicting metadata entries from the first reference source, the first structured knowledge base, and the first individual website and removing the conflicting metadata entries from the merged metadata prior to responding to the POI search request.

Another embodiment of the computing device may further include means for querying the first reference source and a second online reference source; means for identifying an individual POI from first individual POI metadata of the first reference source and second individual POI metadata from the second online reference source; means for identifying first POI compatible metadata for the individual POI and first POI conflicting metadata for the individual POI from the first individual POI metadata and the second individual POI metadata; means for using the first POI compatible metadata and removing the first POI conflicting metadata to create first individual POI merged metadata; and means for responding to the POI search request with the first individual POI merged metadata prior to querying the first structured knowledge base.

Another embodiment of the computing device may further include means for identifying the individual POI from third individual POI metadata of the first structured knowledge base; means for identifying second POI compatible metadata for the individual POI and second POI conflicting metadata for the individual POI from the first individual POI merged metadata and the third individual POI metadata; means for updating the first individual POI merged metadata using the second POI compatible metadata and the second POI conflicting metadata to create a second individual POI merged metadata; and means for updating the response to the POI search request by responding to the POI search request with the second individual POI merged metadata.

Additional embodiments of the computing device may function where identifying metadata entries from the plurality of data sources which match the POI search request comprises: receiving responses to the querying of the plurality of data sources, the responses comprising individual POI metadata; and updating, over time as the responses are received, the merged metadata by identifying compatible metadata and conflicting metadata for each individual POI using the language analysis module; and wherein responding to the POI search request using the merged metadata comprises communicating a plurality of merged metadata updates as the responses are received and the merged metadata is updated over time.

Still further embodiments of the computing device may include means for including the compatible metadata for each individual POI result in the merged metadata and excluding the conflicting metadata from the merged metadata; and means for communicating the merged metadata updates each time the merged metadata is updated as responses to queries are received.

Another alternative embodiment may be a computing device comprising: a wireless communication module; a memory coupled to the wireless communication module; and a processor coupled to the wireless communication module and the memory, wherein the processor: identifies a plurality of data sources each having a data source priority, the plurality of data sources comprising at least two of: a first reference source, a first structured knowledge base, and a first individual website; queries the plurality of data sources for metadata associated with a POI search request, wherein a query order is based on the data source priority for each of the plurality of data sources; measures at least one source quality for each of the plurality of data sources; and updates the data source priority for the plurality of metadata sources using the at least one source quality for each of the plurality of data sources.

While various specific embodiments are described, a person of ordinary skill in the art will understand that elements, steps, and components of the various embodiments may be arranged in alternative structures while remaining within the scope of the description. Also, additional embodiments will be apparent given the description herein, and thus the description is not referring only to the specifically described embodiments, but to any embodiment capable of the function or structure described herein.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system that may incorporate one or more embodiments;

FIG. 2 illustrates aspects of one potential method that may operate in accordance with one or more embodiments;

FIG. 3 illustrates a simplified diagram of a device that may be used in accordance with one or more embodiments;

FIG. 4 illustrates aspects of one potential method that may operate in accordance with one or more embodiments;

FIG. 5 illustrates one potential embodiment of a computing device that may be used with aspects of one or more embodiments of various systems and devices.

FIG. 6 illustrates one potential embodiment of a network that may be used with aspects of one or more embodiments of various systems and devices.

### DETAILED DESCRIPTION

Aspects of the disclosure relate to networked searches for points of interest computing technologies. In particular, systems, device, and methods for use in sorting and organizing data providers as part of point of interest searches are described. Additional embodiments may describe using this orchestration with feedback and performance analysis to improve point of interest (POI) searches.

For example, in one potential embodiment, a person who uses a system according to an embodiment may be a passenger in a car who wants to search for a place to eat. This system user may create a POI search request using a mobile phone, with the POI search request comprising the phrase “nice places to eat near me.” The mobile device may then integrate a current location of the user with the request, and communicate the POI search request to a server that may process the request.

At the server, a language analysis module may process the search for “nice places to eat” which are near the provided location to identify restaurants with certain characteristics as determined by the language analysis module's interpretation of the search phrase. The server may have access to a large number of potential data sources which may identify points of interest relevant to such a search. In order to avoid taking an excessive amount of time before providing a response, the server may prioritize the potential data sources with data source quality metrics. After interpreting the POI search request with the language analysis module, the system may begin sending a series of queries to data sources, beginning with the highest priority data sources.

Because different data sources may respond with different latencies, the responses to the queries may not all be received at the same time. Instead of waiting for all queries to be responded to, the system may take POI metadata from the data sources as it is received, and respond to the POI search request with a stream of response data. As more and more results are received at the server, metadata for each point of interest may be merged, and compatible or conflicting metadata for each point of interest may be used to create the merged metadata. Updates may then be streamed to the user for each POI identified during the search as the merged metadata is created.

Additionally, as responses from different data sources are received at the server, a quality associated with each data source from which a response is received may be measured. For example, the total time from communication of the query to a particular data source to receipt of the response from that data source may be measured as a data source quality. Additionally, the quantity or quality of information may be measured as a data source quality. This analysis to determine the data source quality may occur in real-time as the responses are received, or may be analyzed at a later time to efficiently use resources.

Thus, a system according to such a potential embodiment may provide POI search data in an accelerated manner from hierarchically organized data sources based on quality, with a system for continuously measuring and updating the quality of data sources.

As described herein, a “point of interest” is an individual physical location that matches a set of descriptors. Such a point of interest may be described by its physical location using an address, a coordinate, or an indication on a map, and may further be associated with a wide variety of metadata describing details of the location. For example, a restaurant, a museum, a statue in a fixed location, a sign, or any other such location may be considered a point of interest. In certain instances, a point of interest such as a food truck may be considered a point of interest even if it is not permanently fixed at a particular location.

A “point of interest search request” refers to a set of descriptors, phrases, questions, or user inputs that may be used to identify points of interest. For example “restaurants,” “restrooms,” “car rental,” and/or any other such descriptors may be used to identify points of interest as part of a search request.

“Point of interest metadata” and “metadata” as used herein refers to characteristics which describe individual points of interest, and which may differentiate individual points of interest from each other when the points of interest are responsive to a single search request. For example, POI metadata may include an address, phone number, opening times, food/drinks served, type of food, prices, user reviews, physical descriptions, and so on.

A “data source” refers to a computing device which stores metadata associated with individual POIs. Data sources may be further distinguished based on the structure, name, presentation, quality, operator, and/or any other attribute of the data source.

“Merged metadata” refers to metadata from multiple data sources which is aggregated into a single set of metadata describing an individual point of interest. The process used for merging such metadata may exclude conflicting metadata data, or may set confidence levels for metadata based on the trustworthiness of data sources from which the metadata was received. Aspects of the process for merging metadata may be set based on user preference and feedback from previous searches. If a reference source with a one week old update for a particular POI and an individual web site for the POI both identify a phone number for the POI, while a two year old entry in a knowledge base identifies a separate phone number, merged metadata may include the compatible metadata from the first two sources and reject the conflicting metadata from the knowledge base. In other embodiments all such metadata may be rejected, or all such metadata may be merged, with details of the conflict included in the merged metadata depending on user or system settings. Additional description of such merged metadata is described below.

“Compatible metadata” as used herein refers to metadata from multiple data sources that agrees with or corroborates the other metadata. Such metadata need not be exact duplicates of other compatible metadata, but may simply be metadata which makes another piece of metadata more likely to be correct by implication or inference in a way that may be analyzed and identified by a POI search computer or rule engine.

On the other hand, “conflicting metadata” is metadata which makes another piece of metadata less likely to be correct. Metadata which directly contradicts other metadata is conflicting metadata. For example, one piece of metadata stating that a location is closed at a particular time while another piece of metadata stating the location will be open at that same time is conflicting metadata. Metadata which does not directly conflict, but which by analytical inference may make another piece of metadata less likely to be true may also be conflicting metadata.

“Data source quality” refers to information about responses from a data source. Response time or time from communication of a query to receipt of a response is one potential data source quality. Data quantity measuring a volume of useful data from a source or how much data a data source provides on average in response to a query may be another data source quality. Also, correctness of the data received from a data source may be another data source quality. Such qualities may be assessed immediately upon receipt of a response from a data source, such as in the case of response time measurements. Correctness and completeness qualities may require additional analysis, and may rely on measurement and analysis of many responses over time.

“Data source priority” refers to a metric which is based on data source quality information to determine when and what order to use when requesting information from a data source. Such a priority may be set as a number created by analysis of data source quality information. For example, average response time may be used directly as the data source priority, with lower response times being assigned earlier priority in the ordering of queries to data sources. In other embodiments, users may select preferred data sources, and this preference may be further integrated with measurement of completeness, correctness, and response time measurements to generate a data source priority for each data source using a weighted formula. Additional embodiments may measure cost associated with a particular data source, or any other such system for weighting the response time with other relative values of particular metadata from a data source.

Standard location-based services for point of interest (POI) searches retrieve POI metadata from a single source or data provider on a network. POI metadata retrieved by such searches may include, for example, an address, phone number, opening time, food/drinks served, and so on. Google Places™, Yelp.com™ and OpenStreetMap™ are all instances of services providing this metadata. However, even if some data providers offer accurate and well-maintained metadata, none provide comprehensive and consistent information for individual POIs. For example, Google Places may include metadata to find opening times for a given restaurant, however, accurate metadata describing the type of food served at that restaurant may be listed by a separate data provider such as the crowd-sourced OpenStreetMap™, or on the restaurant's website. The metadata format and semantics is also not homogeneous across such different data sources. For example, while certain data sources may offer the POI address, this may be identified by different labels, such as “Address” or “Location”. Some data sources may also use the full address in a single string, whereas others split it into parts (number, street, postal/zip code, country). The same is true for other information such as phone numbers or alternative place names. Finally, POI coverage in different areas and by different data providers may be quite variable, even for major providers. A particular challenge emerges in handling large retail parks/shopping centers that contain multiple businesses. In this case only one or a few major businesses (e.g. a supermarket) may be listed by some data providers as a point of interest, even if other facilities are available (e.g. a vehicle fueling station attached to the supermarket complex).

In addition, because such searches may not be organized by an entity with direct connections to the physical locations or points of interest being searched, the quantity and quality of data available for such searches may vary widely, and may come from a large variety of potential sources. As businesses move or change, data from some sources may be out of date for a particular point of interest. Due to the complexities of integrating data from multiple sources and the unique demands that users may have when requesting information on points of interest

FIG. 1 describes one embodiment of a system for hierarchical orchestration of data providers in the retrieval of POI metadata. The system of FIG. 1 includes device 110, user 101, POI search computer 120, and a plurality of data sources 155. Device 110 may be any computing device such as a cell phone, a laptop computer, a tablet computer, a desktop computer, an automobile location assistance device, or any such device capable of accepting an input from user 101 to create a POI search request 112, and to communicate the POI search request 112 to a POI search computer 120.

While the embodiment of FIG. 1 shows a search created on device 110 with additional processing and queries performed in separate POI search computer 120, in alternative embodiments such as the embodiment shown by FIG. 3, the processing, language analysis, and queries may be performed by device 110, essentially integrating device 110 and POI search computer 120 into a single computing device.

POI search computer 120 includes POI search processing and quality measurement module 130, language analysis module 150, and metadata communication module 140. Module 130 may function to manage communication with some or all of devices that send POI requests to POI search computer 120, including POI search request 112 from device 110. In certain embodiments, module 130 may first manage a search for points of interest, and then manage a search for additional metadata from a plurality of data sources, while in other embodiments module 130 may function to direct a search for points of interest and associated POI metadata as an integrated search. Additionally, in various embodiments, language analysis may also be used on the received POI search request as part of the identification of individual POIs responsive to the POI search request.

As POI search requests from users are processed by module 130, each POI search request such as POI search request 112 is used to create queries to multiple different data sources. As module 130 processes POI search request 112, appropriate data sources 155 are identified. In certain embodiments, at least a portion of the data sources may be standardized for all POI search requests, while in other embodiments, the entire set of data sources may be customized and determined based on an analysis of the individual POI search request. As part of this, data sources 155 may be a subset of all the data sources available to POI search computer 120, or may include all of the data sources available for POI search computer 120.

Further still, module 130 either stores or has access to a data source priority for each of the data sources available to POI search computer 120. Such data source priorities may be based on a number of factors. In one potential embodiment, the data source priority is based only on an expected or measured history of response times, in order to prioritize response speed in issuing queries. In other embodiments, a weighted formula of multiple factors may be used to create the data source priority value for each data source. A non-limiting set of examples of factors may include historical metadata response quantity, historical metadata response quality, cost associated with the metadata, user-set weighting factors, or any other such factor. Examples of user-set weighting factors may include a preference not to use certain data sources or not to see any response for an individual POI until a certain type of metadata is identified or identified with a certain level of confidence for the individual POI.

After the queries and priorities are identified by module 130, the system may then communicate queries and priorities 132 to metadata communication module 140. This module 140 may function to manage the communication of the multiple queries based on the associated priorities as they are passed to data sources 155. In certain embodiments, metadata communication module 140 may function to create multi-threaded queries while using an order identified by the data source priorities. In alternative embodiments, this communication of queries may be managed in different ways. In one potential embodiment, the queries may be sent as quickly as possible to individual data sources based on queries and priorities 132. Such a system, however, may create bottleneck issues if an excessive number of queries are sent and/or an excessive number of responses are received simultaneously, and may also cause problems in a fully loaded system as a large number of queries associated with a single search are sent. In alternative embodiments, each query may be sent individually based on priority level, with module 140 waiting for a response prior to sending an additional query. Such embodiments may include a time-out in case a particular response stalls or is dropped by a data source 155. In a similar embodiment, a certain number of queries may be sent prior to a response being received, with a new query sent whenever a response is received. Five queries may be sent, for example, with the sixth and subsequent queries only being sent when a response is received. In certain embodiments, if enough data is received from any one of the queries (or accumulation of metadata from previous queries), further querying may be stopped and data presented to the user.

In still further embodiments, data sources 155 may be further classified and organized into groups. One potential example of such a grouping is a grouping of reference sources, such as reference source 160, structured knowledge databases such as structured knowledge base 170, and individual locations such as individual web site source 180. Reference sources may be, for example, commercial databases, online tourist guides, online point of interest guides, commercial crowdsourcing databases, or other such public sources of standard knowledge. Structured knowledge bases may comprise online directories such as OpenStreetMap™ or Google Places™. Such structured knowledge bases may be crowd-sourced, professionally edited and maintained, or a mixture of the two. Such structured knowledge bases may be password protected or include payment requirements to access the information provided by in a way that may slow down access to the information. Individual websites may be one or more publicly available standalone web sites that describe an individual point of interest. Such web sites may be created an operated by businesses or owners of the point of interest, or by third party public individuals who create web sites for the purpose of describing the point of interest in its own website, and not as part of a database, knowledge base, or guide. Such sites may be parsed or scraped individually to identify metadata associated with an individual point of interest.

Grouping of data sources in such a fashion may enable additional ordering in the communication of queries to the data sources. For example, in one embodiment grouped data providers in a certain category may be assigned a default data source priority. All data providers of a certain category may be in a priority band such that all such data sources are higher priority than all data sources from a different category. The data sources are then queried in series according to their priority within the category. Each individual source may have a varying priority within the group, and this priority may vary over time as the performance of an individual data source changes.

In another potential embodiment, the highest priority data source for each category may be queried first. For example, the highest priority reference source may be queried first as query 162. After a response is received as metadata 164, the highest priority structured knowledge base may be queried as query 172. After response metadata 174 is received, the highest priority individual website may be queried as query 182. After the response metadata 184 is received, additional queries to data sources may proceed in in order of quality regardless of group.

In such an embodiment, the system will first receive metadata 164 from reference source 160 at module 140. Then metadata 164 may be sent to module 130 along with quality data associated with metadata 164 such as response time. The system may immediately respond to POI search request 112 using metadata 164 as part of response 190. In alternate embodiments, the system may wait for merged metadata to be created. If a response is to be sent using metadata 164 prior to any merger with other metadata, language analysis module 150 may analyze metadata 164 to associate information in metadata 164 with predefined system categories. For example, metadata 164 may include location information labeled as “address” while the system may identify such information with a “location” identifier as described below.

In this example, when metadata 174 is later received at module 130 and sent to language analysis module 150, merged metadata may be created by integrating metadata 164 with metadata 174. The metadata retrieved by different data providers may vary semantically. This means that the address for a POI may be referred as “Address=X” by reference source 160 and as “Location=Y” by structured knowledge base 170 despite X and Y being the same value. The POI type can be “type=Cinema” for a cinema in one data source, but may be classified as “type=Movie Theatre” by a different data source. In order to reconcile these semantic differences, language analysis module 150 may use a language ontology that encodes a vocabulary or thesaurus.

Such an ontology can be used to find similarities and match metadata entries (e.g. “Cinema” will be considered similar to “Movie Theatre”) through a similarity algorithm that runs on an ontology network (or graph). If two similar entries are identified, the system may compare the value of the entry values: in case the values are the same (e.g. if X=Y above), then X can be returned as it is. Otherwise if X is not equal to Y, a string/value similarity algorithm can be used to detect how similar the two values are. If they are similar then either can be returned, otherwise the values are inconsistent and they may be discarded as conflicting metadata.

After metadata is merged, the merged metadata is sent to device 110 as response 190. If a response was previously sent using only metadata 164, then the merged metadata may be sent as a merged metadata update. This may send the complete merged metadata to replace the previously sent metadata. Alternatively the merged metadata update may only include changes from the previous metadata sent to device 110.

In this example, as additional metadata such as metadata 184 is received, processed, and merged, additional metadata updates may be sent to device 110. Metadata belonging to different groups will be returned at different times because data sources respond at different times and certain queries may be gated by reception of previous responses. The initial response 190 can be used to quickly provide device 110 a POI overview for user 101 while additional metadata is being retrieved over the network. If more metadata becomes available, the interface on device 110 adapts to present the additional information received as updated merged metadata. In certain embodiments, at any point the user can interrupt the stream of updated merged metadata to stop receiving additional updates, or the user may elect to have all merged metadata shown immediately upon receipt without having to wait for all the metadata to be displayed.

Further, at any time during or after receipt of metadata, module 130 may function to enable or direct quality measurement related to queries for individual POIs. For example, as each response metadata and source quality data message 188 is conveyed to module 130, the module may identify the source quality data and immediately update a source quality. Subsequent queries to that data source may use the updated source quality. For example, if the source quality data is a response time in a system where data source priority is based on a set of response time metrics, the system may immediately update the response time metrics and an associated source priority rating. Alternatively, the source quality data may be stored and analyzed at a later time to update data source priorities.

Additionally, in certain embodiments, the metadata itself may be considered source quality data. In such embodiments, mechanisms may be set to assess the value of the metadata. For example, user feedback or quality control may identify when metadata from a particular source is incorrect. Such systems may additionally be automated to create a review or an indication when the metadata from a particular data source conflicts with metadata from other sources, or when user feedback from device 110 indicates that metadata was false. System feedback may identify a source quality rating or weight based on the frequency with which metadata from a particular data source is identified to be in error, and the data source priority may be based on such a rating.

In additional embodiments the mechanism described above can be implemented as a set of rules within a rule engine or rule module within any computing device. The grouping and prioritization of data providers may be realized by appropriate use of rule salience. Merging and reconciliation of rules for metadata can also be implemented within the rule engine knowledge base, which may include language analysis as described above. A rule engine thus may comprise a set of modules or functional elements which apply rules as described above to order data sources on priority determined from measured data source qualities.

Additionally, it will be understood that a single POI search request may identify multiple points of interest that are appropriately responsive to a single search request. The system and methods described above may thus concurrently request metadata for a plurality of POIs from a single data source. In one potential embodiment, an initial search for POIs is performed by module 130 or managed by module 130 in conjunction with a POI identification system. Once a sufficient number of POIs are identified, queries and metadata responses for each individual POI identified are managed through metadata communication module 140. Such queries for individual POIs may be grouped and sent together, but still may comprise queries for information about individual POIs. The responses with metadata for individual POIs may similarly be received separately or as a group, and then metadata for individual POIs may be merged with language analysis module 150.

In an alternative embodiment, the POIs may not initially be identified by module 130. Instead, initial queries to data sources may be based on the information in the POI search request 112. Individual POIs may then be identified by module 130 using response metadata such as metadata 164, 174, and 184. Metadata may then be merged using language analysis module 150, but in such embodiments, additional queries may be created using the identified POIs from response metadata. For example, if a response from reference source 160 in metadata 164 identifies a POI, an additional query may be made to scrape and/or parse details from an individual website 180 associated with the identified POI. When individual website 180 is identified, it may be placed in order with any other outstanding queries based on a data source quality identified for the individual web site. A default source quality for an individual web site may automatically place that data source at the bottom of the list, or an indication that the individual web site has important information which is missing from initial response metadata may give the individual website a high data source quality so that it will jump to the head of the query order.

While various descriptions above are described with respect to the particular embodiment of FIG. 1, it will be understood that alternative embodiments, including those described as well as additional embodiments, may function with the elements of FIG. 1 in different order, or with the elements separated, merged, or organized in alternative structures while still performing the functions as described above.

FIG. 2 now describes a method which may serve as an embodiment. While the method of FIG. 2 may be described with respect to elements of the system of FIG. 1, it will be understood that it may additionally function with other embodiments, including the device of FIG. 3, or other computing devices or networked systems that may perform the functions described by any element or module.

In S202, a computing device including a rule engine for processing metadata processes a POI search request. The computing device may be a server such as POI search computer 120 of FIG. 1, or may be a device such as mobile device 300 of FIG. 3. In such embodiments, the modules for language analysis, POI search processing, and data source quality measurement may be considered part of a rule engine for processing metadata.

In S204, the computing device identifies, using a search processing module such as module 130, a plurality of data sources. Each data source has a data source priority value stored in the system or accessible by such a search processing module. As described above, such priority may be based on a response time, a user selection, data quality, history data measured by the system over time, or any other such data. The plurality of data sources may comprise at least two different groups or types of data sources, including two selected from a set of groups including a first reference source such as reference source 160, a first structured knowledge base such as structured knowledge base 170, and a first individual website such as individual website 180.

In S206, the plurality of data sources from S204 are queried for metadata associated with the search request. This query process may be managed by a module such as metadata communication module 140 to make these queries in order based on the data source quality from S204.

In S208, the computing device receives responses to the queries, for example, by metadata communication module 140. For a multithreaded system, the responses may be received in an order that is different from the order in which the queries were sent due to performance differences between data sources.

In S210, the computing device measures at least one source quality, such as response time, for each of the plurality of data sources, using, for example POI search and quality module 130 of FIG. 1 or data source quality module 326 of FIG. 3.

In S212, the computing device may identify metadata entries for the plurality of data sources which match the POI search request using language analysis to merge metadata from multiple sources. While a single language analysis module 150 is shown in FIG. 1, in various embodiments the analysis of metadata entries for individual points of interest may be analyzed in multiple different ways by combinations of multiple analysis systems to identify metadata for each POI responsive to the POI search request of S202.

In S214, the computing device responds to the POI search request using the merged metadata to, for example, communicate merged metadata from module 130 to device 110 of FIG. 1, or to display the merged metadata from POI search processing 324 on display module 303 of FIG. 3.

In S216, data source priority either stored on or accessible by the computing device is updated using the measured source quality for each data source. This update may occur as the data is received, or may be stored in a batch to be processed at a time schedule when computing resources for quality analysis are available.

FIG. 3 is block diagram illustrating one potential embodiment of a mobile device that may be used in conjunction with embodiments described herein to implement hierarchical orchestration of data providers for POI searches. The system may be a mobile device 300, which may be any mobile device such as a smart phone, cellular phone, personal digital assistant, tablet computer, personal media player as well as any other type of portable electronic device offering similar or combined functionality. It should be appreciated that device 300 may also include tactile buttons, a power device (e.g., a battery), as well as other components typically associated with a portable electronic device. Accordingly, FIG. 3 is not to be construed as limiting because some components are omitted.

In contrast to FIG. 1, where a device 110 is shown as merely forwarding a POI search request to a POI server 120, in FIG. 3, the mobile device 300 may perform processing and language analysis to merge metadata from multiple data sources. Such processing may be performed by any combination of hardware circuitry, firmware, or software modules on mobile device 300 in networked communication with data sources such as data sources 155 of FIG. 1. In FIG. 3, the modules for orchestrating data sources and processing metadata are shown as language analysis module 322, POI search processing 324, metadata communication module 325, and data source quality module 326.

In certain embodiments, POI search processing 324 may perform functions similar to those of POI search processing and quality measurement module 130. Similarly, in certain embodiments, multithreaded metadata communication 325 may perform functions similar to those of metadata communication module 140 of FIG. 1. While in FIG. 1, POI search request 112 and response 190 are communicated via a network between device 110 and POI search computer 120, in FIG. 3, such requests and responses may be received via a user input module 304 and output to a user via display module 303.

While these are shown in FIG. 3 as separate modules stored in memory 320 for execution by processor 310, in various embodiments, these may be structured as a single application, or as any combination of hardware, software, and firmware operating on a computing device with one or more processors. In some embodiments, one or more of the modules 321-326 are implemented by the processor 310. These modules may communicate with data sources via wireless communication module 311 on bus 340, or via any other acceptable means. Additionally, such modules for orchestrating data sources and processing metadata may function along with other application modules 321 using an operating system 323 of mobile device 300.

Mobile device 300 may thus include an interface for receiving a POI search request. This may pass the POI search request to POI search processing to identify POIs, data sources, and priorities for data sources which may be passed to multithreaded metadata communication module 325. This module may communicate with data sources via wireless communication module 311 connecting to a network, and may receive response metadata. The response metadata may be merged using language analysis module 322, and presented to the user on display module 303. In some embodiments, language analysis module 322 may be configured to perform the functions described above with respect to language analysis module 150. Just as described above, the merged metadata updates may be streamed and updated on display module 303 as additional updates are received, and user settings and selections may be made to alter or adjust presentation or search characteristics in response to user inputs.

In the embodiment shown at FIG. 3, device 300 includes processor 310 configured to execute instructions for performing operations at a number of components and can be, for example, a general-purpose processor or microprocessor suitable for implementation within a portable electronic device. Processor 310 is communicatively coupled with a plurality of components within mobile device 300. To realize this communicative coupling, processor 310 may communicate with the other illustrated components across a bus 340. Bus 340 can be any subsystem adapted to transfer data within mobile device 300. Bus 340 can be a plurality of computer buses and include additional circuitry to transfer data. In some embodiments, the bus 340 is implemented in a System on Chip (SoC) and connects various elements or components on the chip and/or cores of one or more processors.

Memory 320 may be coupled to processor 310. In some embodiments, memory 320 offers both short-term and long-term storage and may in fact be divided into several units. Memory 320 may be volatile, such as static random access memory (SRAM) and/or dynamic random access memory (DRAM) and/or non-volatile, such as read-only memory (ROM), flash memory, and the like. Furthermore, memory 320 can include removable storage devices, such as secure digital (SD) cards. Thus, memory 320 provides storage of computer readable instructions, data structures, program modules, and other data for mobile device 300. In some embodiments, memory 320 may be distributed into different hardware modules.

In some embodiments, memory 320 stores a plurality of application modules 321. Application modules 321 contain particular instructions to be executed by processor 310. Memory 320 can store any number of application modules. These modules may additionally include one or more modules for hierarchical orchestration of data providers in POI searches as described above.

In some embodiments, memory 320 includes an operating system 323. Operating system 323 may be operable to initiate the execution of the instructions provided by application modules 321 and/or manage hardware modules 301-302. Operating system 323 may be adapted to perform other operations across the components of device 300 including threading, resource management, data storage control and other similar functionality.

In some embodiments, mobile device 300 includes a plurality of hardware modules 301-302. Each of hardware modules 301-302 is a physical module within device 300. However, while each of hardware modules 301-302 is permanently configured as a structure, a respective one of hardware modules 301-302 may be temporarily configured to perform specific functions or temporarily activated. A common example is an application module that may program a camera module (i.e., hardware module) for shutter release and image capture. A respective one of hardware modules 301-302 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 301-302 may be implemented in software. In various embodiments, data from any of such hardware modules may be integrated with a POI search request to identify potential POIs of relevance. In the simplest example, location data from any such sensor may be used to identify a user location in association with an acceptable distance for POIs associated with the search.

Device 300 may include a component such as wireless communication module 311. Wireless communication module 311 may be configured to receive signals from various devices such data sources via networks and access points. Wireless communication module 311 may be configured to transmit signals to another such as a POI search computer 120 of FIG. 1. In certain embodiments, a portion of any element described such as language analysis or POI search processing may be performed by both a mobile device 300 and a separate POI search computer such as POI search computer 120 of FIG. 1.

In addition to hardware modules 301-302 and application modules 321, mobile device 300 may have a display module 303 and a user input module 304. Display module 303 graphically presents information from device 300 to the user. This information may be derived from one or more application modules 321, one or more hardware modules 301-302, a combination thereof, or any other suitable means for resolving graphical content for the user (e.g., by operating system 323). Display module 303 can be liquid crystal display (LCD) technology, light emitting polymer display (LPD) technology, or some other display technology. In some embodiments, display module 303 is a capacitive or resistive touch screen and may be sensitive to haptic and/or tactile contact with a user. In such embodiments, the display module 303 can comprise a multi-touch-sensitive display.

Additional embodiments of a mobile device may further comprise various portions of computing devices as are detailed below with respect to FIG. 5 and networks as detailed in FIG. 6.

FIG. 4 now describes an additional method that may function in accordance with various embodiments. The method of FIG. 4 may function in conjunction with the system of FIG. 1, the mobile device of FIG. 3, or with any other system or structure that may perform the steps described in FIG. 4. In S402, defaults are set for a system, and as part of this the system may identify a plurality of data sources for use by a rule engine in responding to POI search requests. As described above, such a rule engine may comprise the elements described in FIG. 1 or 3 for hierarchically orchestrating data sources as part of POI search. As a further part of system initialization, the system may set a default data source priority in the rule engine for each data source of the plurality of data sources.

For example, as described above the data sources may first be sorted by groups. Such groups may include references sources with data either extracted from online references such as tourist guides, or gathered from local individuals. Such groups may also include online structured knowledge bases or ontologies and online directories. Such groups may also include individual POI websites where metadata needs to be retrieved from the website by scraped and parsing information directly from the web page or pages.

In certain embodiments above options may be considered to be in order of availability and technical difficulty. References sources may be usually static and easy sources to retrieve and encode metadata from, so a standard relational database can be used to maintain it. On the other hand, it may be very unlikely to find information for a specific POI, rather it is possible to extract information about classes of POIs such as restaurants, cinemas, and other similar classes. Such information may be inferred to a specific POI even if the data is not directly tied to a specific POI.

Structured knowledge bases by contrast may provide metadata for individual POIs. This metadata may present different degrees of accuracy according to the original source (crowd-sourced vs. professionally edited). One issue with these data sources is that the metadata semantics may vary with time when API updates or new service release occur.

Finally, accurate metadata may be extracted from the website associated with a POI, on the condition that the website is known. Scraping, where an entire website is parsed for metadata, may be the most demanding task for deriving metadata among the described groups, as it requires time and a set of semantic rules to filter out irrelevant content such as boilerplate text.

Given the above groupings, in certain embodiments each data source within a particular group may be assigned a default setting as part of S404 which provides an initial data quality. Assumptions may then be made about the query orders based on the above. In this example, reference sources which provide “common-sense” and “default knowledge” applicable to POIs have databases that are queried first as they are assumed to be the fastest to retrieve POI metadata. Subsequently, structured knowledge bases are queried to retrieve more specific POI metadata at a slightly higher time cost, and possible a reference webpage for the POI. Finally webpage scraping is used on the website (if possible) to retrieve accurate information, but at a higher time cost. The default data source priority for each data source of S404 may be structured to reflect these assumptions in the system.

In S406, then, after the defaults and initial need to identify potential data sources are structured, the system may receive a POI search request at the rule engine. In response, at S408 the system may create queries for the plurality of data sources over time, with the order of queries based on the data source priority for each of the plurality of data sources, such that higher priority data sources are queried first.

In S410, the system may receive responses over time at the rule engine to the queries. Following this in S412, each time a response is received with individual POI metadata, a determination is made by the language analysis module if the received metadata is compatible or conflicting with previously received metadata for the individual POI, and the merged metadata is updated.

Throughout system operation as described by S414, each time a response is received, one or more source qualities are measured, and may be used to update the data source priority for the data source that the response was received from. In various embodiments, individual searches may be associated with quality measurements and analysis only a portion of the time. For example, a sampling may be used in systems with a high volume of search requests in order to reduce overhead associated with individual searches. In other embodiments, this may be dynamic. For example, a particular data source may have a quality measurement taken during every search when the data source is first being analyzed by the system. When a system has a sufficient baseline of data, the system may reduce the frequency with which quality data is taken. For example, quality may only be measured every few hundred searches. If such sample measurements begin to indicate that a change in quality is occurring, the system may respond by increasing the frequency of quality measurement. Similarly, in a search that draws information from multiple data sources, quality measurements may be taken for some data sources and not for other data sources within the context of a single search request and response. Similarly, over time responses to queries are received and metadata is merged and updated. In S416 multiple merged metadata updates are communicated to the POI search requestor over time as responses are received and the merged metadata is updated

The systems and methods above thus manage alternative metadata sources such as POI web services, common-sense/local knowledge databases, scraped and parsed web pages, and any additional metadata inferred on the basis of what was collected. The metadata does not need to be stored or maintained as the mechanism may work at run-time and merge the metadata from multiple sources every time a POI search request is received. This may further provide a more comprehensive set of metadata for POIs, where the user can directly benefit from the extra information when choosing among POIs. The extra information can also be used by context-aware applications to better understand the user's preferences and choices and profile the type of area the user is in, such as an understanding of residential, commercial, or city center areas. These systems and methods may also provide better experience for the user as quicker metadata sources can be exploited to provide basic POI information quickly, while more details are retrieved from alternative sources such as webpages.

Additionally, these systems and methods may provide denser POI coverage in locations where individual POI databases are sparse by searching multiple data sources. Further still, a more scalable and robust handling of metadata information retrieval may be provided, since a single failing metadata source will not prevent the user from receive any information about POIs, and multiple source can be prioritized according to their response times and metadata quality. In certain embodiments with real-time or near real-time analysis of data source quality, the real-time nature of the analysis may provide increased responsiveness to data updates at data sources, and may further reduce the need to create an independent permanent database of merged metadata.

FIG. 5 illustrates an example of a computing system in which one or more embodiments may be implemented. A computer system as illustrated in FIG. 5 may be incorporated as part of the previously described computerized devices in FIGS. 1 and 3. Additionally, any computing device as described herein may include any combination of components. For example, device 110, POI search computer 120, or any of data sources 155 may be structured using the computing device 500 of FIG. 5 or any element of computing device 500. Additionally, in various embodiment, elements, such as language analysis module 150, POI search processing and quality measurement module 130, or metadata communication module 140 may be structured as stand-alone computing devices, or structured as any functional mix of computing elements described herein. FIG. 5 provides a schematic illustration of one embodiment of a computer system 500 that can perform the methods provided by various other embodiments, as described herein, and/or can function as a device 110, mobile device 400, POI search computer 120, reference source 160, structured knowledge base 170, or individual web site. FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like. In certain embodiments, processor 310 of mobile device 300 may be equivalent to processor 510. In certain embodiments, input devices 515 may be equivalent to user input module 304 of mobile device 300.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a Bluetooth™ device, an 502.11 device, a Wi-Fi device, a WiMax device, cellular communication facilities, etc.), and/or similar communication interfaces. The communications subsystem 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a POI search computer can comprise hardware and/or software that is specialized (e.g., an application-specific integrated circuit (ASIC), a software method, etc.) or generic (e.g., processor(s) 510, applications 545, etc.) Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. For example, language analysis module 150, POI search processing and quality measurement module 130, and metadata communication module 140 may be implemented using such elements of FIG. 5. Similarly, any modules shown in memory 320 of FIG. 3 may be implemented in such elements of FIG. 5.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communications subsystem 530 (and/or the media by which the communications subsystem 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a non-transitory storage device 525 either before or after execution by the processor(s) 510.

In various embodiments as described herein, computing devices may be networked in order to send and receive POI search requests, responses, queries, metadata responses, and other communications. For example POI search request 112, response 190, queries 162, 172, and 182, as well as response metadata 164, 174, and 184 of FIG. 1 may be network communications. FIG. 6 illustrates a schematic diagram of a system 600 of networked computing devices that can be used in accordance with one set of embodiments. The system 600 can include one or more user computing devices 605. The user computing devices 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computing devices 605 can also have any of a variety of applications, including one or more applications configured to perform methods of the invention, as well as one or more office applications, database client and/or server applications, and web browser applications. Alternatively, the user computing devices 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computing devices 605, any number of user computing devices can be supported.

Certain embodiments of the invention operate in a networked environment, which can include a network 610. The network 610 can be any type of network familiar to those skilled in the art that can support data communications using any of a variety of commercially-available protocols, including, without limitation, TCP/IP, SNA, IPX, AppleTalk, and the like. Merely by way of example, the network 610 can be a local area network (“LAN”), including, without limitation, an Ethernet network, a Token-Ring network and/or the like; a wide-area network (WAN); a virtual network, including, without limitation, a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks.

Embodiments of the invention can include one or more server computers 660. Each of the server computers 660 may be configured with an operating system, including, without limitation, any of those discussed above, as well as any commercially (or freely) available server operating systems. Each of the servers 660 may also be running one or more applications, which can be configured to provide services to one or more user computing devices 605 and/or other servers 660.

Merely by way of example, one of the servers 660 may be a web server, which can be used, merely by way of example, to process requests for web pages or other electronic documents from user computing devices 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computing devices 605 to perform methods of the invention.

The server computers 660, in some embodiments, might include one or more application servers, which can include one or more applications accessible by a client running on one or more of the client computers 605 and/or other servers 660. Merely by way of example, the server(s) 660 can be one or more general purpose computers capable of executing programs or scripts in response to the user computing devices 605 and/or other servers 660, including, without limitation, web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™ Microsoft™, Sybase™, IBM™, and the like, which can process requests from clients (including, depending on the configurator, database clients, API clients, web browsers, etc.) running on a user computing device 605 and/or another server 660. Data provided by an application server may be formatted as web pages (comprising HTML, Javascript, etc., for example) and/or may be forwarded to a user computing device 605 via a web server (as described above, for example). Similarly, a web server might receive web page requests and/or input data from a user computing device 605 and/or forward the web page requests and/or input data to an application server. In some cases a web server may be integrated with an application server.

In accordance with further embodiments, one or more servers 660 can function as a file server and/or can include one or more of the files (e.g., application code, data files, etc.) necessary to implement methods of the invention incorporated by an application running on a user computing device 605 and/or another server 660. Alternatively, as those skilled in the art will appreciate, a file server can include all necessary files, allowing such an application to be invoked remotely by a user computing device 605 and/or server 660. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 660a (and/or a user computing device 605). Alternatively, a database 620b can be remote from any or all of the computers 605 or servers 660, so long as the database 620b can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605 or servers 660 can be stored locally on the respective computer and/or remotely, as appropriate.) In one set of embodiments, the database 620 can be a relational database, such as an Oracle™ database, that is adapted to store, update, and retrieve data in response to SQL-formatted commands. The database might be controlled and/or maintained by a database server, as described above, for example. In various embodiments, any of data sources 155 may be structured according to such embodiments. For example, reference source 160 or structured knowledge base 170 may be structured as a database 620a which is accessed via a server 660a. Alternatively, certain of data sources 155 may be directly accessible databases similar to database 620b. Individual web site 180 may be operated by a stand-alone server 660b. In various alternative embodiments, any such data sources 155 may be operative on any device of FIG. 6 based on the structure created by the operator of the data source.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application various embodiments. Also, a number of steps may be undertaken before, during, or after the above elements are considered. Accordingly, the above description does not limit the scope of the disclosure.

What is claimed is:

1. A method comprising:
processing at a computing device, a point of interest (POI) search request;
identifying a plurality of data sources each having a data source priority, the plurality of data sources comprising at least two of: a first reference source, a first structured knowledge base, and a first individual website;
querying the plurality of data sources for metadata associated with the POI search request, wherein an order of the querying is based on the data source priority for each of the plurality of data sources; and
measuring at least one source quality for at least one of the plurality of data sources.

2. The method of claim 1 further comprising:
receiving, in response to querying the plurality of data sources, metadata entries from the plurality of data sources which match the POI search request;
merging the metadata entries from the plurality of data sources using a language analysis module to create merged metadata from the plurality of data sources;
responding to the POI search request using the merged metadata; and
updating the data source priority for the at least one of the plurality of data sources using the at least one source quality for the at least one of the plurality of data sources.

3. The method of claim 2 wherein the plurality of data sources comprises the first reference source and the first structured knowledge base;
wherein a data source priority for the first reference source is greater than a data source priority for the first structured knowledge base; and
wherein querying the plurality of data sources comprises:
querying the first reference source for metadata associated with the POI search request; and
after querying the first reference source, querying the first structured knowledge base for metadata associated with the POI search request.

4. The method of claim 3 wherein measuring at least one source quality for each of the plurality of data sources comprises:
measuring a response time of the first reference source; and
measuring a response time of the first structured knowledge base.

5. The method of claim 4 wherein the plurality of data sources further comprises the first individual website.

6. The method of claim 5 wherein the data source priority for the first structured knowledge base is greater than the data source priority for the first individual website; and
wherein querying the plurality of data sources further comprises:
after querying the first structured knowledge base, querying the first individual website.

7. The method of claim 6 wherein the data source priority for the first reference source, the data source priority for the first structured knowledge base, and the data source priority for the first individual website are each default data source priorities.

8. The method of claim 7 wherein a default data source priority for each reference source of the plurality of data sources is greater than a default data source priority for each structured knowledge base of the plurality of data sources.

9. The method of claim 8 wherein the default data source priority for each structured knowledge base of the plurality of data sources is greater than the default data source priority for each individual web page of the plurality of data sources.

10. The method of claim 5 further comprising identifying conflicting metadata entries from the first reference source, the first structured knowledge base, and the first individual website and removing the conflicting metadata entries from the merged metadata prior to responding to the POI search request.

11. The method of claim 5 further comprising:
querying the first reference source and a second online reference source;
identifying an individual POI from first individual POI metadata of the first reference source and second individual POI metadata from the second online reference source;
identifying first POI compatible metadata for the individual POI and first POI conflicting metadata for the individual POI from the first individual POI metadata and the second individual POI metadata;
using the first POI compatible metadata and removing the first POI conflicting metadata to create first individual POI merged metadata; and
responding to the POI search request with the first individual POI merged metadata prior to querying the first structured knowledge base.

12. The method of claim 11 further comprising:
identifying the individual POI from third individual POI metadata of the first structured knowledge base;
identifying second POI compatible metadata for the individual POI and second POI conflicting metadata for the individual POI from the first individual POI merged metadata and the third individual POI metadata;
updating the first individual POI merged metadata using the second POI compatible metadata and the second POI conflicting metadata to create a second individual POI merged metadata; and
updating the response to the POI search request by responding to the POI search request with the second individual POI merged metadata.

13. The method of claim 2 wherein the data source priority is determined using one or more of an expected response time, a user preference selection, or a data quality measurement.

14. The method of claim 2 wherein identifying metadata entries from the plurality of data sources which match the POI search request comprises:
receiving responses to the querying of the plurality of data sources, the responses comprising individual POI metadata; and
updating, over time as the responses are received, the merged metadata by identifying compatible metadata and conflicting metadata for each individual POI using the language analysis module; and
wherein responding to the POI search request using the merged metadata comprises communicating a plurality of merged metadata updates as the responses are received and the merged metadata is updated over time.

15. The method of claim 14 wherein merging the metadata entries from the plurality of data sources using the language analysis module to create the merged metadata comprises including the compatible metadata for each individual POI result in the merged metadata and excluding the conflicting metadata from the merged metadata; and
wherein responding to the POI search request comprises communicating the merged metadata updates each time the merged metadata is updated as responses to queries are received.

16. The method of claim 1 wherein the first reference source comprises a telephone directory server or a commercial restaurant guide.

17. The method of claim 1 wherein the metadata for each POI comprises one or more of: an opening time; a closing time; an address; a telephone number; an e-mail address; a food menu; and a business history.

18. A non-transitory computer readable instruction medium comprising instructions that, when executed by a processor, cause a computing device to perform a method comprising:
processing a point of interest (POI) search request;
identifying a plurality of data sources each having a data source priority, the plurality of data sources comprising at least two of: a first reference source, a first structured knowledge base, and a first individual website;
querying the plurality of data sources for metadata associated with the POI search request, wherein an order of the querying is based on the data source priority for each of the plurality of data sources; and
measuring at least one source quality for at least one of the plurality of data sources.

19. The non-transitory computer readable instruction medium of claim 18 wherein the method further comprises:
receiving, in response to querying the plurality of data sources, metadata entries from the plurality of data sources which match the POI search request;
merging the metadata entries from the plurality of data sources using a language analysis module to create merged metadata from the plurality of data sources;
responding to the POI search request using the merged metadata; and
updating the data source priority for the at least one of the plurality of data sources using the at least one source quality for the at least one of the plurality of data sources.

20. A computing device comprising:
a wireless communication module;
a point of interest search processing module configured to identify a plurality of data sources each having a data source priority, the plurality of data sources comprising at least two of: a first reference source, a first structured knowledge base, and a first individual website;
a metadata communication module configured to query the plurality of data sources for metadata associated with a POI search request, wherein an order of the query is based on the data source priority for each of the plurality of data sources; and
a data source quality module configured to measure at least one source quality for at least one data source of the plurality of data sources and update the data source priority for the at least one data source of the plurality of data sources using the at least one source quality.

21. The computing device of claim 20 wherein the metadata communication module receives, in response to querying the plurality of data sources, metadata entries from the plurality of data sources which match the POI search request; and
wherein the point of interest search processing module merges the metadata entries from the plurality of data sources using a language analysis module to create merged metadata from the plurality of data sources.

22. The computing device of claim 21 further comprising:
an output module that responds to the POI search request using the merged metadata;
wherein the data source quality module updates the data source priority for at least one of the plurality of data sources using the at least one source quality for the at least one of the plurality of data sources.

23. The computing device of claim 21 wherein the data source quality module is further configured to measure a first reference source response time and measure a first structured knowledge base response time as part of measuring the at least one source quality for each of the plurality of data sources.

24. The computing device of claim 21 wherein the order of the query is set by the data source quality module as comprising a lowest latency reference source as a first query and a lowest latency structured knowledge base as a second query.

25. The computing device of claim 21 wherein the order of the query is set by the data source quality module as a latency order of the plurality of data sources from fastest to slowest.

26. The computing device of claim 21 wherein the order of the query is based on a cost associated with each data source of the plurality of data sources.

27. The computing device of claim 20 further comprising a user input module; and
a language analysis module configured to receive the POI search request from the user input module and adjust the POI search request based on a language analysis of the POI search request.

28. The computing device of claim 27 wherein the language analysis module is further configured to receive a plurality of responses to the POI search request from the plurality of data sources and analyze the plurality of responses to identify conflicting metadata.

29. The computing device of claim 28 wherein the data source quality module is configured to receive the conflicting metadata from the language analysis module as the at least one source quality for each of the plurality of data sources.

30. The computing device of claim 27 wherein the language analysis module comprises a language ontology module further comprising at least a thesaurus.

31. The computing device of claim 20 further comprising a user input module comprising a microphone, wherein the microphone receives the POI search request as part of a voice request from a user.

32. The computing device of claim 20 wherein the metadata communication module comprises a multithreaded communication module that communicates a second query to a second data source of the plurality of data sources prior to receiving a response to a first query to a first data source of the plurality of data sources.

33. A computing device comprising:
means for processing a point of interest (POI) search request;
means for identifying a plurality of data sources each having a data source priority, the plurality of data sources comprising at least two of: a first reference source, a first structured knowledge base, and a first individual website;
means for querying the plurality of data sources for metadata associated with the POI search request, wherein an order of the querying is based on the data source priority for each of the plurality of data sources; and
means for measuring at least one source quality for at least one of the plurality of data sources.

34. The computing device of claim 33 further comprising:
means for receiving, in response to querying the plurality of data sources, metadata entries from the plurality of data sources which match the POI search request;
means for merging the metadata entries from the plurality of data sources to create merged metadata from the plurality of data sources;
means for responding to the POI search request using the merged metadata; and
means for updating the data source priority for at least one of the plurality of data sources using the at least one source quality for the at least one of the plurality of data sources.
